(19) United States
(12) Patent Application Publication
(10) Pub. No.: US 2021/0303579 A1
(43) Pub. Date: Sep. 30, 2021

(54) INFORMATION PROCESSING DEVICE AND NON-TRANSITORY COMPUTER READABLE MEDIUM

(71) Applicant: FUJIFILM BUSINESS INNOVATION CORP., Tokyo (JP)

(72) Inventor: Kenichiro WATANABE, Kanagawa (JP)

(73) Assignee: FUJIFILM BUSINESS INNOVATION CORP., Tokyo (JP)

(21) Appl. No.: 17/019,995

(22) Filed: Sep. 14, 2020

(30) Foreign Application Priority Data
Mar. 25, 2020 (JP) 2020-054394

(51) Int. Cl. G06F 16/2457; G06F 16/93; H04L 29/08

(52) U.S. Cl. CPC G06F 16/24573; H04L 67/22; G06F 16/93; G06F 16/24575

(57) ABSTRACT

An information processing device includes a processor configured to cause an activity element identifier that identifies an activity element defined in an activity management service, and for which a trail that indicates an electronic document to be registered is plurally defined, to be stored in a memory in association with a channel identifier that identifies a channel defined in a communication service, and cause a trail message indicating the trail selected by a user in the activity management service to be posted to the channel associated with the activity element for which the trail is defined.

### CROSS-REFERENCE TO RELATED APPLICATION

This application is based on and claims priority under 35 USC 119 from Japanese Patent Application No. 2020-054394 filed Mar. 25, 2020.

### BACKGROUND

### (i) Technical Field

The present disclosure relates to an information processing device and a non-transitory computer readable medium.

### (ii) Related Art

Japanese Unexamined Patent Application Publication No. 2007-108827 discloses a workflow system that includes a workflow management system for managing workflows and a bulletin board system. In the workflow system, a message indicating a link to target data (for example, an electronic form of an application for purchasing goods) related to an activity defined in the workflow management system may be posted in the bulletin board system.

### SUMMARY

Meanwhile, an activity management service in which multiple activity elements are defined and multiple electronic documents related to each activity element may be registered has been proposed in the past. In this specification, an electronic document to be registered in relation to each activity element is referred as a “trail”. According to such an activity management service, a user is able to easily understand whether or not a trail related to each activity element has been registered.

One example of an activity management service is a work process management service for managing work processes that include a series of work operations. In this case, for example, each activity element is a step (hereinafter referred to as a work step) included in a work process, and the trail indicates an electronic document (such as an estimate sheet, for example) that is relevant to fulfilling each work step. Obviously, however, the activity management service is not limited to the above.

On the other hand, a communication service in which multiple users are able to submit messages in pre-created channels has been proposed in the past. When one of the multiple users submits a message on a certain channel, other users accessing the channel are able to view the message.

Here, it is conceivable to associate each activity element in an activity management service with each channel in a communication service. By associating each activity element with each channel, discussions related to a certain activity element may take place in the channel associated with the activity element, for example. With this arrangement, a user is able to understand that a message posted to a certain channel is a message related to the activity element associated with the channel.

However, in the case where multiple trails are defined for an activity element, even if a certain user posts a message to a channel with the intention of treating a specific trail as the topic, other users viewing the channel may be unable to understand or have difficulty understanding which trail is the topic of the message.

Aspects of non-limiting embodiments of the present disclosure relate to associating activity elements defined in an activity management service, and for which multiple trails indicating electronic documents to be registered are defined, with channels of a communication service, and also relate to enabling other users viewing the channels to understand which trail is the topic set by a user on the channels associated with the activity elements.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing device including a processor configured to cause an activity element identifier that identifies an activity element defined in an activity management service, and for which a trail that indicates an electronic document to be registered is plurally defined, to be stored in a memory in association with a channel identifier that identifies a channel defined in a communication service, and cause a trail message indicating the trail selected by a user in the activity management service to be posted to the channel associated with the activity element for which the trail is defined.

### BRIEF DESCRIPTION OF THE DRAWINGS

An exemplary embodiment of the present disclosure will be described in detail based on the following figures, wherein:

FIG. 1 is a schematic configuration diagram of a service linking system according to an exemplary embodiment;

FIG. 2 is a diagram illustrating an example of an activity management screen provided to a user terminal by an activity management service;

FIG. 3 is a diagram illustrating an example of a message screen provided to a user terminal by a communication service;

FIG. 4 is a schematic configuration diagram of a service linking device according to the exemplary embodiment;

FIG. 5 is a diagram illustrating a first example of a screen on which a create channel button is displayed for each activity element;

FIG. 6 is a diagram illustrating an example of a channel member setting window;

FIG. 7 is a diagram illustrating a second example of a screen on which a create channel button is displayed for each activity element;

FIG. 8 is a diagram illustrating an example of a screen on which a use channel button is displayed for each activity element having a defined channel, and a select trail button is displayed for each trail;

FIG. 9 is a diagram illustrating an example of a screen on which a message window of a channel of the communication service is displayed inside the screen of the activity management service;

FIG. 10 is a diagram illustrating a state in which a trail document of a trail selected by a user has been posted to the channel associated with the activity element for which the trail is defined;

FIG. 11 is a diagram illustrating a state in which a message indicating the storage location of a trail document of a trail selected by a user has been posted to the channel associated with the activity element for which the trail is defined;

FIG. 12 is a diagram illustrating a state in which a message indicating a trail document of a trail selected by a user has been posted to the channel associated with the activity element for which the trail is defined;

FIG. 13 is a diagram illustrating a state in which a message indicating another superordinate activity element than an activity element for which a trail selected by a user is defined has been posted to the channel associated with the activity element for which the trail is defined; and

FIG. 14 is a flowchart illustrating a flow of processes by the service linking system according to the exemplary embodiment.

### DETAILED DESCRIPTION

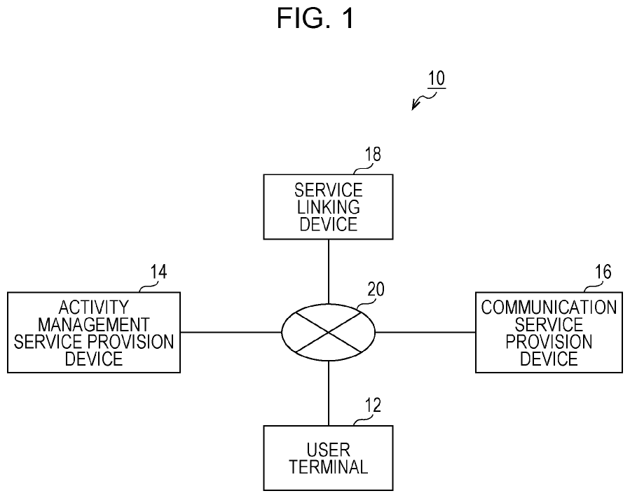

FIG. 1 is a schematic configuration diagram of a service linking system 10 according to an exemplary embodiment of the present disclosure. The service linking system 10 includes one or multiple user terminals 12, an activity management service provision device 14, a communication service provision device 16, and a service linking device 18 that acts as an information processing device. The user terminal(s) 12, the activity management service provision device 14, the communication service provision device 16, and the service linking device 18 are communicably interconnected through a communication channel 20 such as a local area network (LAN) or the Internet.

Each user terminal 12 is a terminal used by a user who uses an activity management service provided by the activity management service provision device 14 and a communication service provided by the communication service provision device 16. Each user terminal 12 is a terminal such as a personal computer, a smartphone, or a tablet, for example. Each user terminal 12 is provided with a communication interface that includes a network adapter or the like, memory that includes a hard disk, RAM, ROM, or the like, a display that includes a liquid crystal display device or the like, an input interface that includes a mouse, a keyboard, a touch panel, or the like, and a processor that includes a CPU, a microcontroller, or the like.

The activity management service provision device 14 is a server computer, for example. Specifically, the activity management service provision device 14 is provided with a communication interface that includes a network adapter or the like, memory that includes RAM, ROM, or the like, and a processor that includes a CPU, a microcontroller, or the like. The activity management service provision device 14 provides the activity management service to users. Specifically, if a user registers with the activity management service and is authenticated by (that is, logs in to) the activity management service, the user is able to use the activity management service. Note that because the activity management service is capable of providing the activity management service to a large number of users, tenants are defined in groups of one or multiple users (where each user group corresponds to a company, for example). With this arrangement, for example, a user belonging to a certain user group (for example, Company A) is only able to access Tenant A corresponding to Company A.

The activity management service is a service that manages user activity. The activity may be any of various types of activity, including but not limited to work, club activity, and personal activity, for example. In the activity management service, a user defines one or multiple activity elements in advance, and the activity management service manages user activity for each of the one or multiple defined activity elements. For example, in the case where the activity management service is a work management service that manages work, each activity element is a work element representing one unit of work for instance. As another example, in the case where the activity management service is a club activity management service that manages club activity, each activity element represents one unit of club activity (such as a practice or a competition, for example). As another example, in the case where the activity management service is a personal activity management service that manages personal activity, each activity element represents one unit of personal activity (such as study or planning, for example).

In the exemplary embodiment, multiple activity elements are defined in a hierarchal structure in the activity management service. For example, in the case where the activity management service is a work process management service that manages work processes, the work processes are defined with respect to a work project, which is a superordinate activity element in the hierarchal structure. Additionally, each work project contains one or multiple inferior activity elements (in other words, activity elements that are performed to carry out the work processes), which are defined as one or multiple work steps. By structuring the activity elements in a hierarchal structure and displaying the hierarchal structure to a user, the user is able to grasp relationships between multiple activity elements appropriately. For example, the user is able to understand that completing a certain work project involves completing multiple subordinate work steps defined for the work project. However, multiple activity elements do not necessarily have to exist in a hierarchal structure.

In this way, in the case where a collection of sequential activities for which one or multiple steps are defined (that is, an activity process) exists in the activity management service, the individual steps correspond to subordinate activity elements and the collective activity process corresponds to a superordinate activity element, but a hierarchal structure of such a type is merely one example. As another example, in the case of a work management service for instance, superordinate categories collecting work projects of the same type may be defined and the individual work projects may be defined as subordinate elements, while in the case of a club activity management service, the superordinate category “Competitions” may be defined and individual competitions such as “Match ABC” and “Match XYZ” may be defined as subordinate elements.

In the activity management service, an electronic document to be registered in relation to each activity element may be defined. As described above, information indicating such an electronic document is called a trail. Particularly, multiple trails are defined with respect to a single activity element. Users are able to register electronic documents in association with each activity element as each trail, and the activity management service manages the electronic documents registered by the users. In this specification, an electronic document registered as a trail is referred to as a “trail document”.

For each activity element, an activity element member allowed to use the activity element may also be defined. For example, an activity process may be defined such that a superordinate activity element (for example, a work project) is usable only by a user in higher position of authority (such as a manager, for example), whereas a subordinate activity element (for example, a work step) is usable by a user responsible for the subordinate activity element (the person in charge, for example) as well as a user able to user the superordinate activity element. A user able to use a superordinate activity element may also be allowed to use the subordinate activity element unconditionally on the basis of the hierarchal structure among the activity elements. Note that being able to use an activity element means either or both of being able to view the activity element and being able to register a trail related to the activity element.

Each of the above definitions related to the activity management service is defined by someone such as a person in the position of managing activity (for example, a superior, a project manager, or a department head) among the users.

In the activity management service, an activity process ID that identifies an activity process, an activity element ID that acts as an activity element identifier that identifies multiple activity elements included in the activity process, a trail ID that identifies a trail defined for each activity element, hierarchy information indicating the hierarchal structure of the multiple activity elements in the activity process, information indicating the activity element members of each activity element, and trail documents registered as each trail are stored in association with each other.

In this specification, an example in which the activity management service is a work process management service that manages work processes is described below. However, as described earlier, the activity management service is not limited to the following.

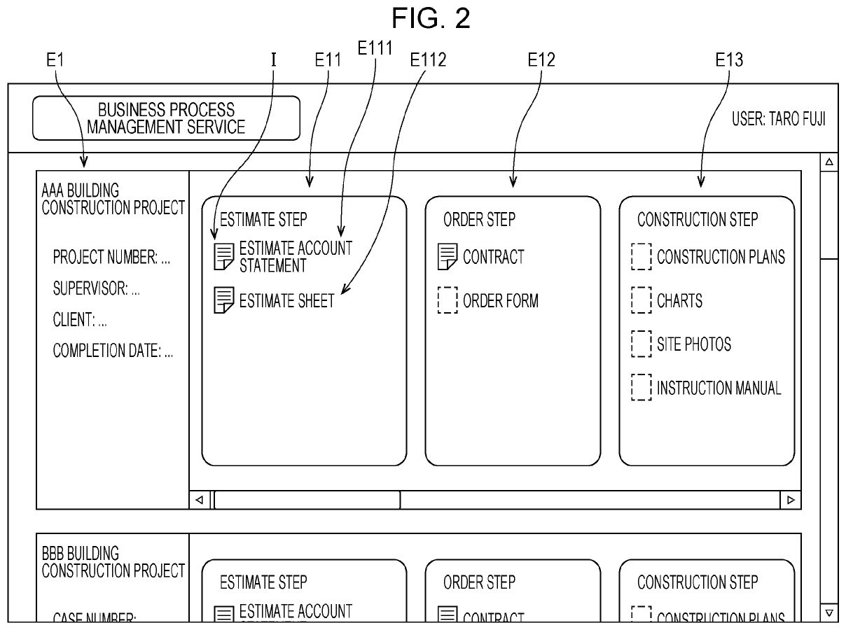

FIG. 2 is a diagram illustrating an example of an activity management screen provided to a user terminal 12 by the activity management service. When a user logs in to the activity management service, an activity management screen like the one illustrated in FIG. 2 is displayed on the display of the user terminal 12. In the exemplary embodiment, on the activity management screen, multiple activity elements for each activity process defined in the activity management service are displayed in a format that indicates the hierarchal structure. It may also be configured such that only the activity elements that are usable by the user are displayed on the activity management screen.

In the exemplary embodiment, a work project is defined as the highest superordinate activity element within a single work process, and work steps included in the project are defined as subordinate activity elements one level below. For example, “AAA Building Construction Project” is defined as the highest superordinate activity element, and “Estimate Step”, “Order Step”, and “Construction Step” are defined as the subordinate activity elements. Obviously, other work steps may also be defined as subordinate activity elements. Also, although not illustrated in FIG. 2, step groups into which multiple work steps are collected may also be defined as activity elements positioned intermediately in the hierarchal structure between the work project and the work steps. For example, a step group “Finishing Step Group” is defined subordinate to the work project “AAA Building Construction Project”, and the work steps “Exterior Finishing Step” and “Interior Finishing Step” are defined subordinate to the step group.

As FIG. 2 illustrates, on the activity management screen, the hierarchical relationship of the multiple activity elements in each of the multiple activity processes is displayed in a format that is understandable to the user. Specifically, inside a frame E1 that represents the highest superordinate activity element (“AAA Building Construction Project”), frames E11, E12, and E13 representing the subordinate activity elements (“Estimate Step”, “Order Step”, and “Construction Step”) are displayed. In the case where more subordinate activity elements (work steps) are defined, frames representing the additional work steps may be displayed by a method such as horizontal scrolling, for example.

Furthermore, in the exemplary embodiment, multiple trails are defined with respect to each work step. A trail in the present example indicates the type of electronic documents to be registered to complete each work step. In the present example, the trail “Estimate Account Statement” and the trail “Estimate Sheet” are defined for the “Estimate Step”, the trail “Contract” and the trail “Order Form” are defined for the “Order Step”, and the trail “Construction Plans”, the trail “Charts”, the trail “Site Photos”, and the trail “Instruction Manual” are defined for the “Construction Step”.

As FIG. 2 illustrates, on the activity management screen, the trails defined for each work step are displayed in a format that is understandable to the user. Specifically, inside the frame E11 that represents a work step, character strings E111 and E112 that represent the trails defined for the work step are displayed. The same applies to the frames E12 and E13 representing the other work steps. As described above, because a trail may also be treated as an activity element, the display format may also be considered to be a format in which the trails that are the subordinate activity elements with respect to a work step that is the superordinate activity element are displayed in a way that clearly indicates the hierarchal structure.

Also, on the activity management screen, the user is able to grasp whether or not each trail document has been registered. In the exemplary embodiment, a trail icon I is displayed beside the character string representing a trail for which a trail document has been registered. The trail icon I is not displayed beside the character string representing a trail for which a trail document has not been registered. Obviously, whether or not a trail document has been registered may also be indicated by another display format. In the example of FIG. 2, in the “AAA Building Construction Project”, the trail icon I is displayed beside the character strings representing the trail “Estimate Account Statement” and the trail “Estimate Sheet” of the “Estimate Step” and also the character string representing the trail “Contract” in the “Order Step”, but the trail icon I is not displayed beside the character strings representing the other trails. With this arrangement, the user is able to easily understand that in the “AAA Building Construction Project”, trail documents have been registered for the trail “Estimate Account Statement” and the trail “Estimate Sheet” of the “Estimate Step” and also for the trail “Contract” in the “Order Step”, but trail documents have not been registered yet for the other trails.

Returning to FIG. 1, the communication service provision device 16 is a server computer, for example. Specifically, the communication service provision device 16 is provided with a communication interface that includes a network adapter or the like, memory that includes RAM, ROM, or the like, and a processor that includes a CPU, a microcontroller, or the like. The communication service provision device 16 provides the communication service to users. Specifically, if a user registers with the communication service and is authenticated by (that is, logs in to) the communication service, the user is able to use the communication service. The provider of the activity management service and the provider of the communication service may be different entities. Note that because the communication service is capable of providing the communication service to a large number of users, tenants are defined in groups of one or multiple users (where each user group corresponds to a company, for example). With this arrangement, for example, a user belonging to a certain user group (for example, Company A) is only able to access Tenant A corresponding to Company A.

In the communication service, a user is able to create (define) a channel. Multiple channels may be defined by multiple users. A channel is a “place” so to speak where multiple users post messages. Multiple users are able to post messages in a created channel, and other users accessing the channel are able to view the posted messages. Also, a user is able to post an electronic document stored in the user terminal 12 to a channel as an attachment. The posted attachment is transmitted to the communication service provision device 16 and stored. The posted attachment is downloadable by other users accessing the channel.

For each channel, channel members who are able to use the channel may be defined. Note that being able to use a channel means either or both of being able to view messages or attachments posted to the channel and being able to post messages or attachments to the channel.

In the communication service, a channel ID that acts as a channel identifier that identifies a channel, messages and attachments posted to the channel, and information indicating the channel members of each channel are stored in association with each other.

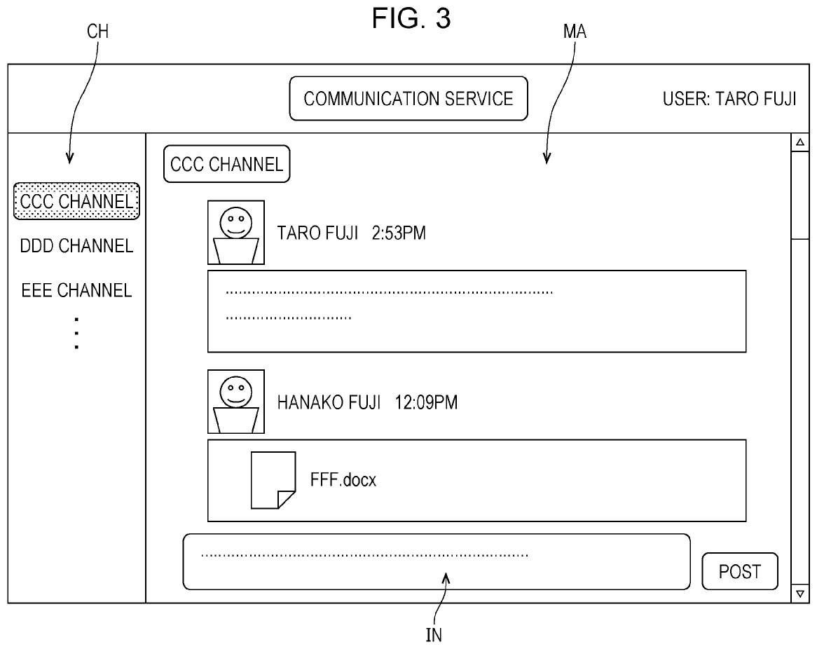

FIG. 3 is a diagram illustrating an example of a message screen provided to the user terminal 12 by the communication service. When a user logs in to the communication service, a message screen like the one illustrated in FIG. 3 is displayed on the display of the user terminal 12. In a channel selection area CH of the message screen, a list of channels defined in the communication service is displayed. It may also be configured such that only the channels usable by the user are displayed in the channel selection area CH. When the user selects a desired channel, message that have been posted to the selected channel are displayed in a main area MA of the message screen. Additionally, a message input field IN is displayed in the main area MA. In other words, the main area MA may be considered to be a usage screen for using the channel. The user is able to post a message to the channel by inputting a message into the message input field IN and pressing a post button. Also, by inputting an electronic document as an attachment in the message input field IN, the user is able to post the electronic document to the channel.

In the communication service, users are able to define multiple channels. In the exemplary embodiment, the multiple channels in the communication service do not exist in a hierarchal structure but rather in parallel, but it is also possible to define a hierarchal structure of multiple channels.

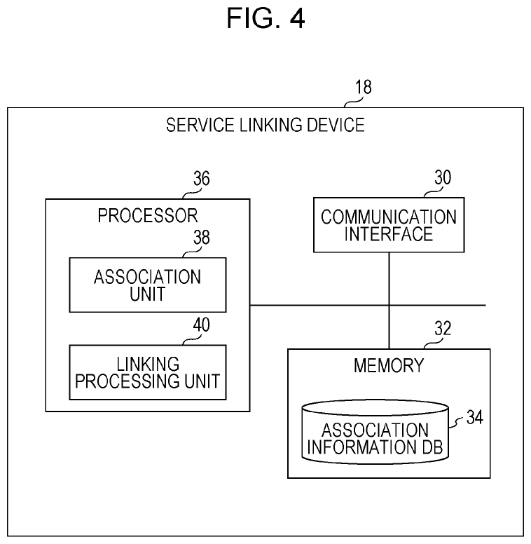

FIG. 4 is a schematic configuration diagram of the service linking device 18. The service linking device 18 includes a server computer, for example. The functions of the service linking device 18 described below may also be achieved by multiple devices (for example, multiple server computers). Also, in the exemplary embodiment, the activity management service provision device 14 and the service linking device 18 are separate devices, but the activity management service provision device 14 and the service linking device 18 may be the same device. Furthermore, the functions of the service linking device 18 described below may also be functions included in the activity management service.

A communication interface 30 includes a device such as a network adapter, for example. The communication interface 30 exhibits a function of communicating with other devices, such as the activity management service provision device 14 and the communication service provision device 16 for example, through the communication channel 20.

Memory 32 includes a hard disk, a solid-state drive (SSD), ROM, RAM, or the like, for example. The memory 32 may be provided separately from a processor 36 described later, or at least a portion of the memory 32 may be provided internally to the processor 36. The memory 32 stores an information processing program for causing each unit of the service linking device 18 to operate. Also, as FIG. 4 illustrates, the memory 32 stores an association information database (DB) 34.

The association information DB 34 is a database in which the activity element ID that identifies each activity element defined in the activity management service and the channel ID that identifies each channel defined in the communication service are associated with each other. The activity element ID and the channel ID are associated by an association unit 38 of the processor 36 described later.

The processor 36 refers to a processing device in a broad sense, and includes at least one general processing device (such as a central processing unit (CPU), for example) or dedicated processing device (such as a graphics processing unit (GPU), an application-specific integrated circuit (ASIC), a field-programmable gate array (FPGA), or a programmable logic device, for example). The processor 36 may be not only a single processing device, but may also be achieved by the cooperation of multiple processing devices existing in apparatuses located physically apart from each other. As FIG. 4 illustrates, the processor 36 exhibits the functions of an association unit 38 and a linking processing unit 40 according to the information processing program stored in the memory 32. Note that in the following description, the association unit 38 and the linking processing unit 40 execute various processes that intervene in the processes of the activity management service. These processes execute the activity management service in accordance with instructions from the association unit 38 and the linking processing unit 40.

On the basis of an instruction from a user, the association unit 38 causes the association information DB 34 to store an activity element ID that identifies an activity element defined in the activity management service and a channel ID that identifies a channel defined in the communication service in association with each other. Hereinafter, details about the processes by the association unit 38 will be described.

First, on the basis of a user instruction, the association unit 38 associates a tenant defined in the activity management service with a tenant defined in the communication service. In the exemplary embodiment, a user accesses the activity management service and inputs, into the activity management service, login information for logging in to the communication service (such as a tenant ID and a password that identify a tenant in the communication service (obviously, a tenant that the user is able to access)). The activity management service performs an authentication process with respect to the communication service on the basis of the input login information, and acquires a tenant ID that identifies the tenant of the user in the communication service. Additionally, a tenant ID that identifies the tenant of the user in the activity management service and a tenant ID that identifies the acquired tenant in the communication service are transmitted to the service linking device 18. The association unit 38 causes the memory 32 to store both received tenant IDs in association with each other.

With this arrangement, the tenant in the activity management service and the tenant in the communication service are associated, thereby enabling communication between the two services. Bidirectional, interactive processes between the activity management service and the communication service are performed by using Web APIs released to the public by each service. The communication may also take security into account and use an object such as a security token. Note that the two services may also be associated with each other by having the user access the communication service and input login information for logging in to the activity management service. The activity element of the activity management service and the channel of the communication service that are associated with each other in the following description are an activity element in a tenant in the activity management service and a channel in a tenant in the communication service that have been associated with each other as described above.

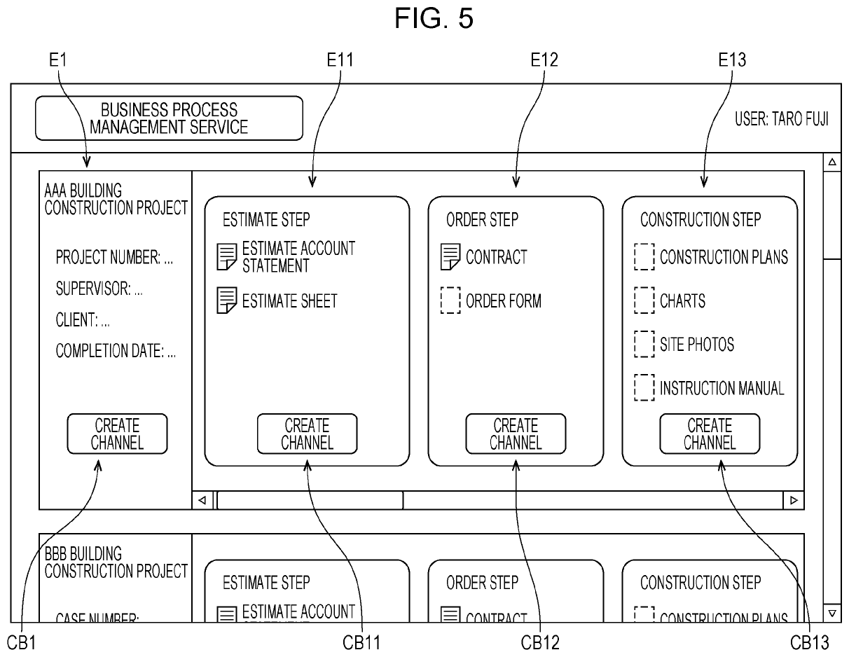

As described above, when a user logs in to the activity management service, the activity management screen is displayed on the display of the user terminal 12, and as illustrated in FIG. 5, the association unit 38 causes a create channel button to be displayed in association with each activity element on the activity management screen. In the example of FIG. 5, the association unit 38 causes a create channel button CB1 to be displayed inside the frame E1 indicating the work project (“AAA Building Construction Project”) that is the highest superordinate activity element within the activity process. The association unit 38 also causes create channel buttons CB11, CB12, and CB13 to be displayed respectively in the frames E11, E12, and E13 that represent the work steps (“Estimate Step”, “Order Step”, and “Construction Step”) that are the subordinate activity elements of the work project. With this arrangement, the user is able to easily understand the relationship between each activity element and each create channel button.

By operating one of the create channel buttons, the user is able to create a channel in the communication service that corresponds to the activity element corresponding to the create channel button. For example, by operating the create channel button CB1, the user is able to create a channel corresponding to the “AAA Building Construction Project”, and by operating the create channel button CB11, the user is able to create a channel corresponding to the “Estimate Step”. Note that, although not displayed in FIG. 5, each trail may also be treated as an activity element, and a create channel button may also be displayed in association with each trail. By operating each create channel button, the user is able to create a channel corresponding to each trail.

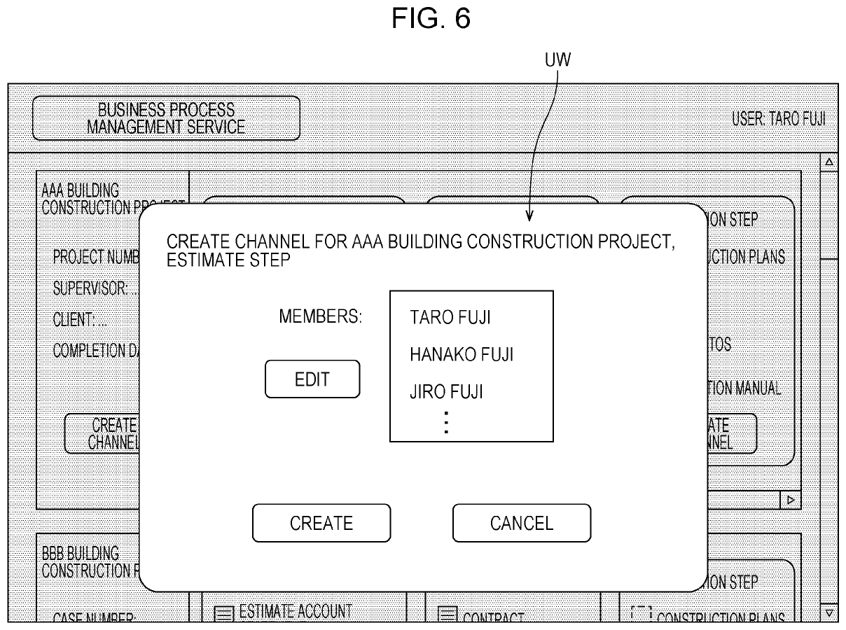

When the user operates one of the create channel buttons (herein assumed to be the create channel button CB11 associated with the “Estimate Step”), a channel member setting window UW like the one illustrated in FIG. 6 is displayed. On the channel member setting window UW, the user is able to set users who will be able to use the channel corresponding to the “Estimate Step” that the user is about to create.

If the user sets one or more channel members and operates a “Create” button on the channel member setting window UW, the activity management service transmits the activity element ID that identifies the activity element corresponding to the create channel button operated by the user and a channel creation instruction to the service linking device 18. The association unit 38 forwards the channel creation instruction to the communication service, thereby causing a new channel to be created (defined) in the communication service. Also, information indicating the set channel members is transmitted from the activity management service provision device 14 to the communication service provision device 16 and set as the channel members of the new channel in the communication service. The communication service transmits a channel ID that identifies the newly created channel to the service linking device 18.

The service linking device 18 causes the association information DB 34 to store the activity element ID indicating the activity element associated with the create channel button operated by the user and the channel ID indicating the current newly created channel received from the communication service in association with each other. With this arrangement, the activity element in the activity management service and the channel in the communication service are associated with each other.

In the case where multiple activity elements in the activity management service exist in a hierarchal structure while multiple channels in the communication service exist in parallel without being in a hierarchal structure, associating each activity element with each channel causes the channels to exist in a hierarchal structure according to the hierarchal structure of the activity elements. In other words, according to the exemplary embodiment, a hierarchal structure of channels may be defined without defining the hierarchal structure of the channels in the communication service.

As described earlier, in the activity management service, activity element members able to use each activity element may be defined in some cases. In the case where activity element members are defined for the activity element associated with the create channel button operated by the user, the association unit 38 may treat the activity element members of the activity element as the channel members of the channel to be created, without causing the channel member setting window UW to be displayed. In this case, the association unit 38 causes the activity management service to transmit information indicating the activity element members of the activity element to the communication service. Alternatively, the activity element members may be set as the initial values of the channel members of the channel to be created, and then the channel member setting window UW described above may be displayed to enable the user to edit the channel members.

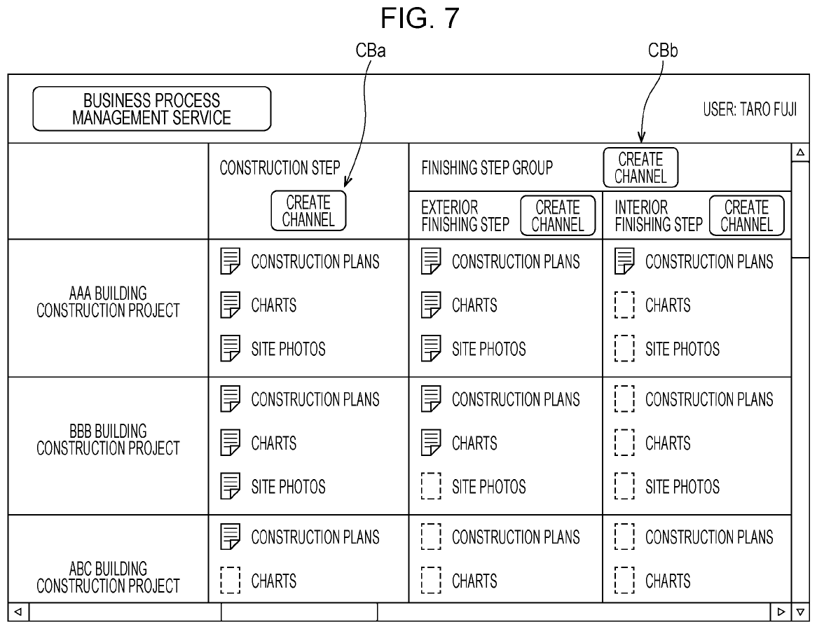

The association unit 38 is also capable of associating multiple activity elements spanning multiple activity processes with a single channel. FIG. 7 is a diagram illustrating another example of the activity management screen. In the example of FIG. 7, a common work step (such as “Construction Step”) is defined for multiple work projects (“AAA Building Construction Project”, “BBB Building Construction Project”, and “ABC Building Construction Project”). In such a case, the association unit 38 is capable of associated multiple work steps spanning the multiple work projects, or in other words the multiple activity processes, with a single channel. Specifically, the association unit 38 may cause a create channel button CBa associated with the work step “Construction Step” spanning multiple work projects to be displayed, and by having the user operate the create channel button CBa, a single channel corresponding to the multiple work steps spanning the multiple work projects may be created.

Note that in FIG. 7, a step group “Finishing Step Group” into which multiple steps are collected is illustrated. Because the step group itself is also an activity element, the association unit 38 obviously may display a create channel button CBb associated with the step group. By operating the create channel button CBb, the user is able to create a channel corresponding to the step group.

Returning to FIG. 4, the linking processing unit 40 executes a process of linking activity elements in the activity management service and channels in the communication service associated with each other by the association unit 38.

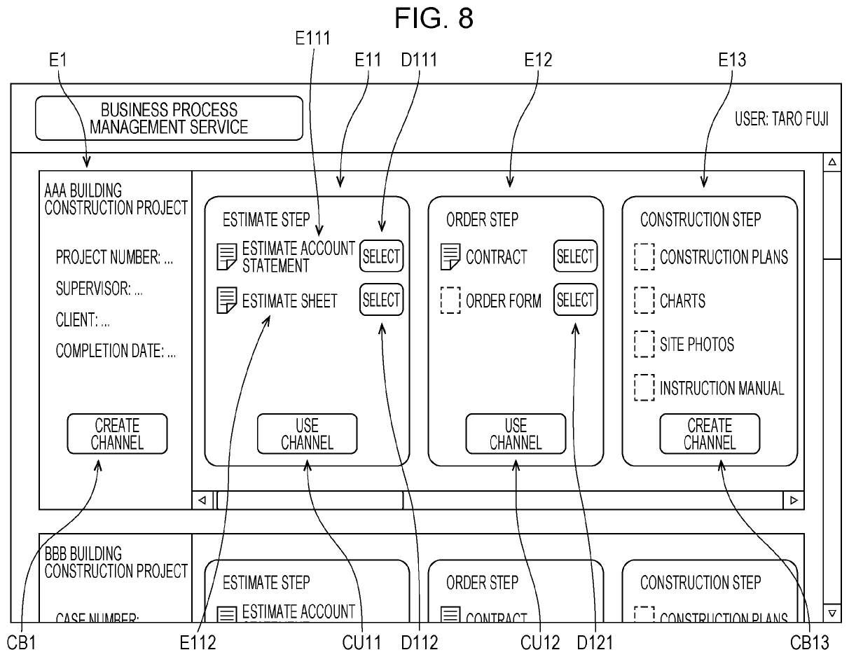

As illustrated in FIG. 8, the linking processing unit 40 causes a use channel button to be displayed in association with each activity element associated with a channel in the communication service on the activity management screen provided by the activity management service. In the example of FIG. 8, use channel buttons CU11 and CU12 are displayed respectively inside the frames E11 and E12 that represent the work steps “Estimate Step” and “Order Step” of the work project “AAA Building Construction Project”. In other words, channels in the communication service are respectively associated with the “Estimate Step” and the “Order Step”. On the other hand, in the example of FIG. 8, because a channel is not associated with the work project “AAA Building Construction Project” or with the work step “Construction Step”, the create channel button CB1 continues to be displayed inside the frame E1 that represents the “AAA Building Construction Project”, and the create channel button CB13 continues to be displayed inside the frame R13 that represents the “Construction Step”.

By operating one of the use channel buttons, the user is able to use the channel in the communication service that corresponds to the activity element corresponding to the use channel button. For example, by operating the use channel button CU11, the user is able to use the channel corresponding to the “Estimate Step” of the “AAA Building Construction Project”. Because each use channel button is displayed in association with a corresponding activity element, the user operating the use channel button is considered to be synonymous with the user selecting the activity element. Consequently, by having the linking processing unit 40 display each use channel button and by having the user select an activity element on the activity management screen, the user is able to use the channel associated with the selected activity element.

When the user operates one of the use channel buttons (herein assumed to be the use channel button CU11 associated with the “Estimate Step”), the activity management service transmits the activity element ID that identifies the activity element corresponding to the use channel button operated by the user and a channel usage instruction to the service linking device 18. The linking processing unit 40 references the association information DB 34, specifies the channel ID associated with the received activity element ID, and transmits the specified channel ID and the channel usage instruction to the communication service. The communication service transmits channel information (such as posted messages for example) related to the channel indicated by the received channel ID to the activity management service.

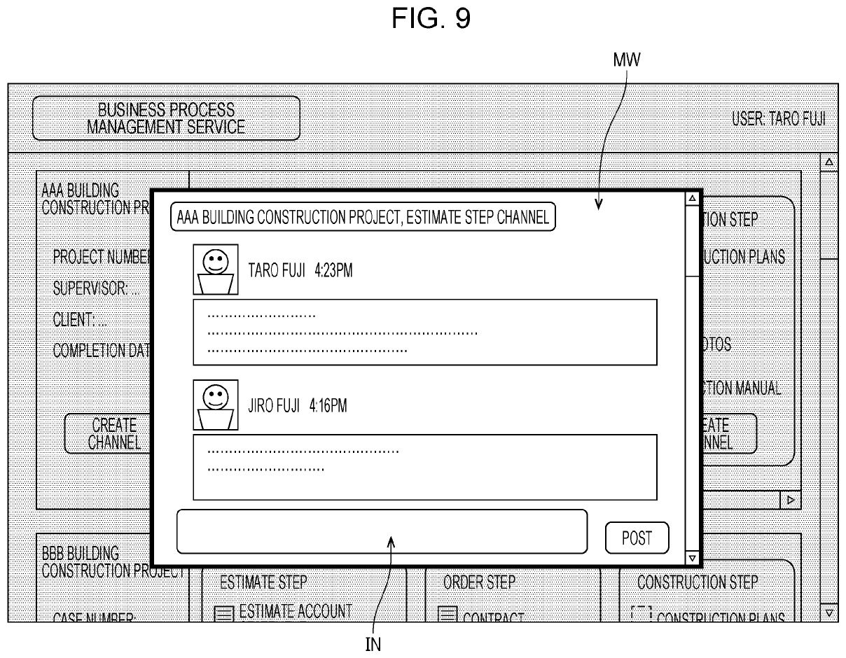

On the basis of the received channel information, the activity management service causes a message window MW including a usage screen for using the channel like the one illustrated in FIG. 9 to be displayed inside the activity management screen on the display of the user terminal 12. In the exemplary embodiment, the main area MA (see FIG. 3) of the message screen described earlier that is displayed on the user terminal 12 by the communication service is displayed in the message window MW. Through the message window MW, the user is able to view messages that have been posted to the channel associated with the “Estimate Step”. The user is also able to post a message to the channel or post an electronic document as an attachment through the message input field IN displayed in the message window MW.

As described above, because the hierarchal structure of the multiple activity elements is clearly indicated on the activity management screen, according to the exemplary embodiment, by selecting an activity element displayed on the activity management screen, the user is able to use the channel associated with the activity element. Consequently, the user is able to understand where the channel to use is positioned in the hierarchal structure of multiple channels (which corresponds to the hierarchal structure of the multiple activity elements, and furthermore use the channel.

By having multiple channels existing a hierarchal structure, processes like the following are possible, for example. First, the channel members of the channel corresponding to a certain work step are set to only persons who are involved with the work step, and the exchange of messages and attachments related to the work step is executed in the channel. An electronic document whose contents are confirmed through such exchange may also be registered as a trail document in the trail of the work step. On the other hand, the channel members of a channel corresponding to a certain work project superordinate to each work step may be set to all persons involved with the work project, and messages related to topics spanning multiple work steps and messages such as reports to a superior may also be posted to the channel.

Also, to cover cases such as where a superior wants to post a message to all persons involved with a work project, a message posted in a superordinate channel (for example, the channel corresponding to the work project) may also be posted to all channels subordinate to that channel (for example, multiple channels corresponding to multiple work steps).

Also, because the message window MW is displayed inside the activity management screen provided by the activity management service, the user is able to use the communication service from the activity management service without accessing the communication service separately.

Referring again to FIG. 8, on the activity management screen provided by the activity management service, the linking processing unit 40 causes a select trail button to be displayed in association with multiple trails defined for activity elements associated with channels of the communication service. For example, select trail buttons D111 and D112 are respectively displayed beside the character string E111 expressing the trail “Estimate Account Statement” and the character string E112 expressing the trail “Estimate Sheet” defined in the “Estimate Step” of the work project “AAA Building Construction Project”.

By operating one of the select trail buttons, the user is able to post a trail message, that is, a message indicating the trail, to the channel associated with the activity element for which the trail corresponding to the select trail button is defined. For example, by operating the select trail button D111, the user is able to post a trail message indicating the trail “Estimate Account Statement” in the channel corresponding to the “Estimate Step” of the “AAA Building Construction Project”. Because each select trail button is displayed in association with each trail, the user operating the select trail button is considered to be synonymous with the user selecting the trail. Consequently, by having the linking processing unit 40 display each select trail button and by having the user select a trail on the activity management screen, the user is able to post a trail message indicating the selected trail to the channel associated with the activity element for which the trail is defined.

If the user operates one of the select trail buttons, the activity management service transmits the trail ID that identifies the trail corresponding to the select trail button operated by the user, the activity element ID that identifies the activity element for which the trail is defined, and a trail message posting instruction to the service linking device 18. The linking processing unit 40 references the association information DB 34, specifies the channel ID associated with the received activity element ID, and transmits the specified channel ID and the trail message posting instruction to the communication service. The communication service posts the trail message indicated by the trail message posting instruction to the channel indicated by the received channel ID, and updates the channel information related to the channel. Additionally, the communication service transmits the updated channel information to the activity management service. On the basis of the received updated channel information, the activity management service causes a message window MW including a usage screen of the channel to which the trail message was posted to be displayed inside the activity management screen on the display of the user terminal 12.

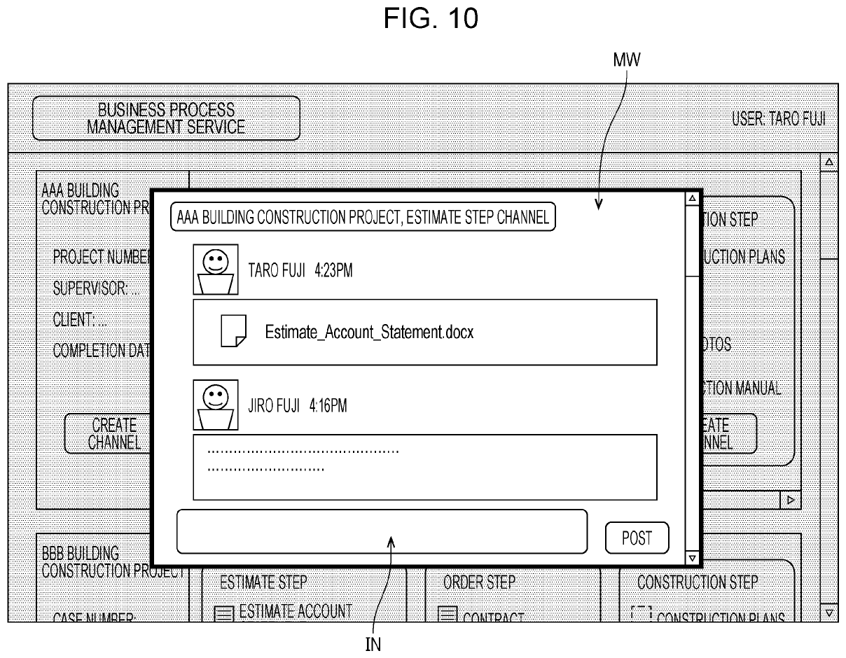

The trail message indicating the trail selected by the user may take various modes and appearances. For example, the trail message may be the trail document itself that is registered as the trail selected by the user. In this case, when the user operates one of the select trail buttons, the trail document registered as the trail corresponding to the select trail button is posted as an attachment to the channel associated with the activity element for which the trail is defined. FIG. 10 illustrates a message window MW that includes a usage screen of the channel to which a trail document (“Estimate_Account_Statement.docx”) registered as the trail corresponding to the select trail button has been posted as an attachment. Note that in the example of FIG. 10, the trail document is automatically posted to the channel in response to the user operating the select trail button, but it may also be configured such that when the user operates the select trail button, the trail document is not posted automatically, and instead the message window MW is displayed in a state in which the trail document is input as an attachment in the message input field IN. With this arrangement, by inputting an additional message into the message input field IN, the user is able to post the attachment together with the additional message to the channel.

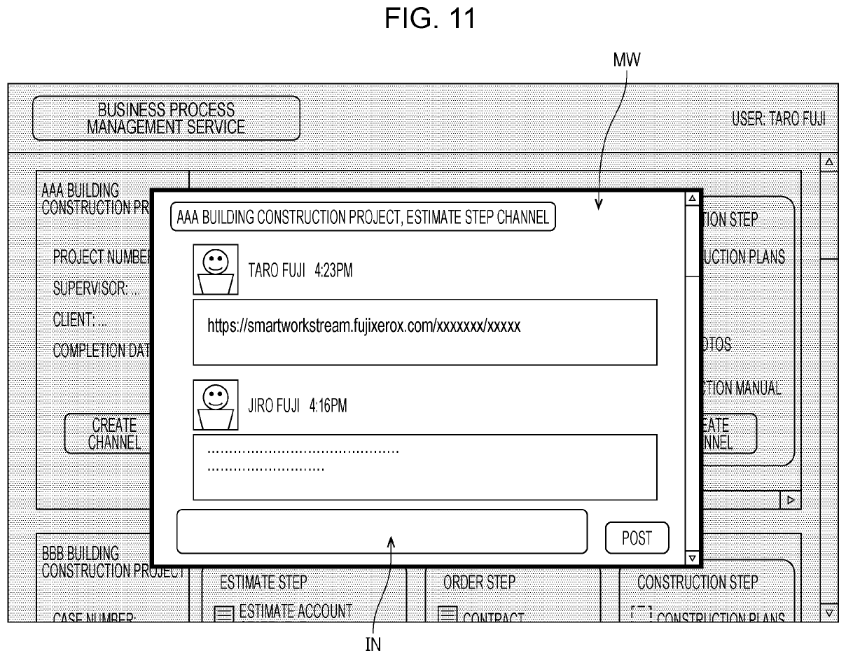

Additionally, the trail message may also be a link message that indicates the storage location of the trail document registered as the trail selected by the user. In this case, when the user operates one of the select trail buttons, a link message that links to the trail document registered as the trail corresponding to the select trail button is posted to the channel associated with the activity element for which the trail is defined. FIG. 11 illustrates a message window MW that includes a usage screen of the channel to which a link message (“https://smartworkstream.fujixerox.com/xxxxxxx/xxxxx”) that links to the trail document registered as the trail corresponding to the select trail button has been posted. Note that in the example of FIG. 10, the link message that links to the trail document is automatically posted to the channel in response to the user operating the select trail button, but it may also be configured such that when the user operates the select trail button, the link message that links to the trail document is not posted automatically, and instead the message window MW is displayed in a state in which the link message that links to the trail document is input in the message input field IN. With this arrangement, by inputting an additional message into the message input field IN, the user is able to post the link message together with the additional message to the channel.

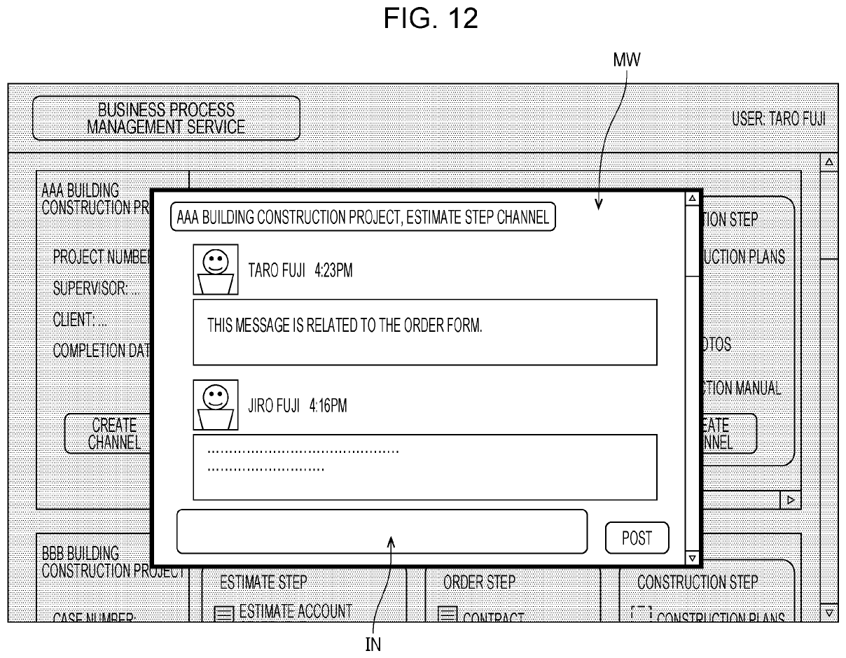

Additionally, the trail message may also be an explanatory message indicating which trail has been selected by the user. In this case, when the user operates one of the select trail buttons, an explanatory message that explains the trail corresponding to the select trail button is posted to the channel associated with the activity element for which the trail is defined. FIG. 12 illustrates a message window MW that includes a usage screen of the channel to which an explanatory message (“This message is related to the order form.”) regarding the trail corresponding to the select trail button has been posted. The user input a message related to the trail following the automatically posted explanatory message. Note that in the example of FIG. 12, the explanatory message regarding the trail is automatically posted to the channel in response to the user operating the select trail button, but it may also be configured such that when the user operates the select trail button, the explanatory message regarding the trail is not posted automatically, and instead the message window MW is displayed in a state in which the explanatory message regarding the trail is input in the message input field IN. With this arrangement, by inputting an additional message into the message input field IN, the user is able to post the explanatory message together with the additional message to the channel.

In the case where the trail message is an explanatory message, the user is also able to select a trail for which a trail document is not registered yet. For example, in FIG. 8, a trail document has not been registered for the trail “Order Form” defined in the “Order Step” of the “AAA Building Construction Project”, but the user is able to select a select trail button D121 corresponding to the trail “Order Form”. When the user selects the select trail button D121, an explanatory message indicating that the trail selected by the user is the trail “Order Form” is posted in the channel associated with the “Order Step”.

In this way, by having the linking processing unit 40 display each select trail button on the activity management screen and by having the user select the select trail button, the user is able to post a trail message that indicates the trail to the channel associated with the activity element for which the trail corresponding to the select trail button is defined. In other words, because the trail that the user wants to treat as the topic is clearly indicated in the channel, other uses viewing the channel are able to clearly grasp which trail the user wants to treat as the topic.

In the case where multiple activity elements are defined in a hierarchal structure in the activity management service, when the user operates one of the select trail buttons, a trail message may be posted as described above, while in addition, a hierarchy message indicating at least a part of the hierarchal structure that includes the activity element for which the trail corresponding to the select trail button is defined may also be posted to the channel associated with the activity element for which the trail is defined.

In this case, if the user operates one of the select trail buttons, the activity management service transmits the trail ID that identifies the trail corresponding to the select trail button operated by the user, the activity element ID that identifies the activity element for which the trail is defined, a trail message posting instruction, and in addition, a hierarchy message generated on the basis of the hierarchy information indicating the hierarchal structure of the multiple activity elements, to the service linking device 18. The hierarchy message is a message indicating the activity element for which the trail selected by the user is defined and other activity elements superordinate or subordinate to the activity element in the hierarchal structure. For example, in the case where the activity element is the “Estimate Step”, the hierarchy message is “>AAA Building Construction Project>Estimate Step>Estimate Account Statement” to indicate the hierarchal structure in which the work project “AAA Building Construction Project” is the superordinate activity element and the trail “Estimate Account Statement is the subordinate activity element.

The linking processing unit 40 references the association information DB 34, specifies the channel ID associated with the received activity element ID, and transmits the specified channel ID as well as instructions for posting the trail message and the hierarchy message to the communication service. The communication service posts the trail message and the hierarchy message indicated by the trail message posting instruction to the channel indicated by the received channel ID, and updates the channel information related to the channel. Additionally, the communication service transmits the updated channel information to the activity management service. On the basis of the received updated channel information, the activity management service causes a message window MW including a usage screen of the channel to which the trail message was posted to be displayed inside the activity management screen on the display of the user terminal 12.

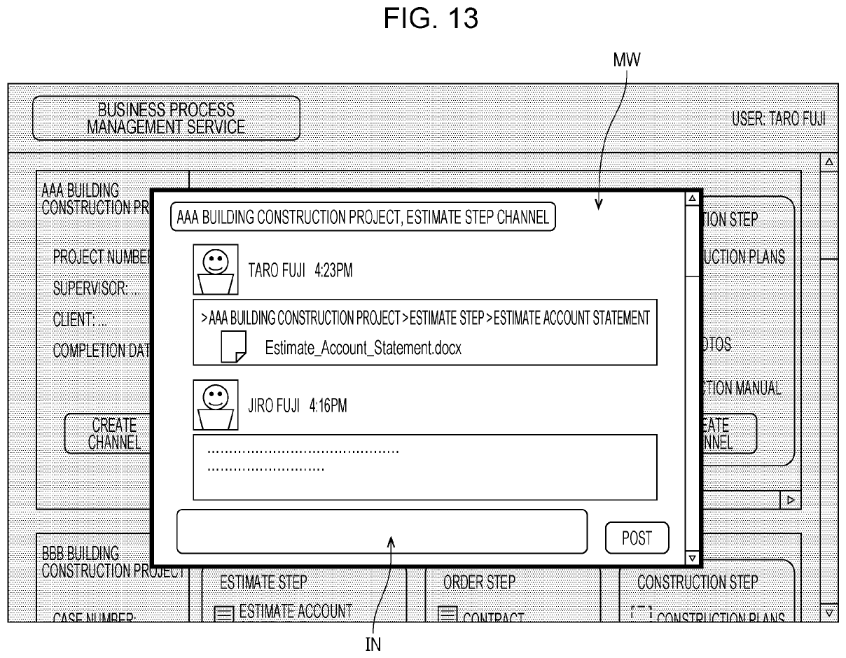

FIG. 13 illustrates a message window MW that includes a usage screen of the channel to which a trail document “Estimate Account Statement.docx”) has been posted as a trail message, and also to which a hierarchy message (“>AAA Building Construction Project>Estimate Step>Estimate Account Statement”) has been posted. Note that in the example of FIG. 13, it may also be configured such that the trail message and the hierarchy message are not posted automatically, and instead the message window MW is displayed in a state in which the trail message and the hierarchy message are input in the message input field IN.

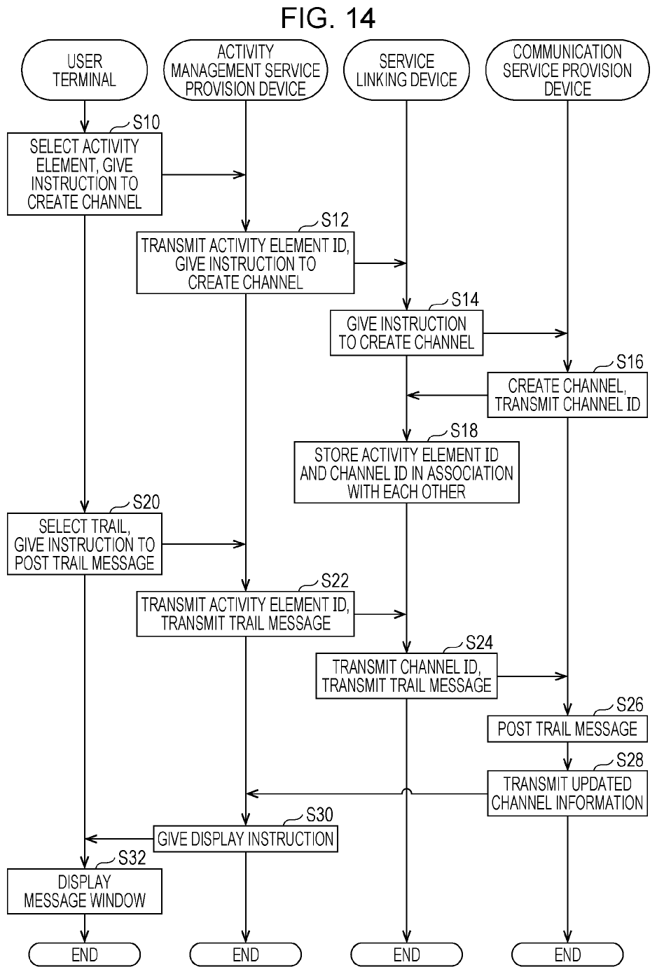

Hereinafter, the flow of processes by the service linking system 10 will be described by following the flowchart illustrated in FIG. 14. It is assumed that when the flowchart in FIG. 14 starts, the tenant of a user in the activity management service and the tenant of the user in the communication service have already been associated with each other. In the flowchart in FIG. 14, steps S10 to S18 are steps related to a process of associating an activity element in the activity management service with a channel in the communication service, while step S20 and thereafter are steps related to a process of using the channel in the activity management service.

In step S10, on the activity management screen (see FIG. 5) displayed on the user terminal 12, the user operates the create channel button displayed in association with each of multiple activity elements displayed hierarchically. Consequently, the activity element ID that identifies the activity element corresponding to the operated create channel button and a channel creation instruction are transmitted from the user terminal 12 to the activity management service provision device 14.

In step S12, the activity management service provision device 14 forwards the received activity element ID and the channel creation instruction to the service linking device 18.

In step S14, the association unit 38 of the service linking device 18 forwards the received channel creation instruction to the communication service provision device 16.

In step S16, the communication service provision device 16 creates a new channel according to the received channel creation instruction. Additionally, the communication service provision device 16 transmits a channel ID that identifies the created channel to the service linking device 18.

In step S18, the association unit 38 of the service linking device 18 causes the association information DB 34 to store the activity element ID received in step S12 and the channel ID received in step S16 in association with each other.

In step S20, on the activity management screen (see FIG. 8) displayed on the user terminal 12, the user operates a select trail button displayed in association with a trail. Consequently, the trail ID that identifies the trail corresponding to the operated selected trail button and a trail message posting instruction are transmitted from the user terminal 12 to the activity management service provision device 14.

In step S22, the activity management service provision device 14 generates a trail message indicating the trail on the basis of the received trail ID. Here, it is assumed that the trail message is a trail document registered as the trail. The activity management service provision device 14 transmits the received activity element ID and the trail document acting as the trail message to the service linking device 18.

In step S24, the linking processing unit 40 of the service linking device 18 references the association information DB 34 and specifies the channel ID associated with the received activity element ID. Additionally, the linking processing unit 40 transmits the specified channel ID to the communication service provision device 16 and also forwards the trail document acting as the trail message to the communication service provision device 16.

In step S26, the communication service provision device 16 posts the received trail document acting as the trail message to the channel indicated by the received channel ID. Consequently, the channel information for the channel is updated.

In step S28, the communication service provision device 16 transmits the updated channel information for the channel to the activity management service provision device 14.

In step S30, the activity management service provision device 14 receiving the updated channel information transmits a display instruction for displaying the updated channel information to the user terminal 12.

In step S32, on the basis of the received display instruction, the user terminal 12 displays the message window MW (see FIG. 10) on the basis of the updated channel information inside the activity management screen already being displayed on the display.

The foregoing describes an exemplary embodiment of the present disclosure, but the present disclosure is not limited to the exemplary embodiment, and various modifications are possible without departing from the scope of the present disclosure.

In the embodiment above, the term “processor” refers to hardware in a broad sense. Examples of the processor include general processors (e.g., CPU: Central Processing Unit), and dedicated processors (e.g., GPU: Graphics Processing Unit, ASIC: Application Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing device comprising:
a processor configured to
cause an activity element identifier that identifies an activity element defined in an activity management service, and for which a trail that indicates an electronic document to be registered is plurally defined, to be stored in a memory in association with a channel identifier that identifies a channel defined in a communication service, and
cause a trail message indicating the trail selected by a user in the activity management service to be posted to the channel associated with the activity element for which the trail is defined.

2. The information processing device according to claim 1, wherein
in the activity management service, one or a plurality of steps involved in completing an activity process are defined as the activity element, and
the trail is plurally defined for at least one of the one or plurality of steps.

3. The information processing device according to claim 1, wherein
the processor is configured to cause an electronic document registered as the trail to be posted as the trail message.

4. The information processing device according to claim 2, wherein
the processor is configured to cause an electronic document registered as the trail to be posted as the trail message.

5. The information processing device according to claim 1, wherein
the trail message is a message indicating a storage location of an electronic document registered as the trail.

6. The information processing device according to claim 2, wherein
the trail message is a message indicating a storage location of an electronic document registered as the trail.

7. The information processing device according to claim 1, wherein
even in a case where the user selects a trail that is not registered, the processor is configured to cause the trail message to be posted to the channel associated with the activity element for which the trail is defined.

8. The information processing device according to claim 2, wherein
even in a case where the user selects a trail that is not registered, the processor is configured to cause the trail message to be posted to the channel associated with the activity element for which the trail is defined.

9. The information processing device according to claim 1, wherein
in the activity management service, a plurality of activity elements are defined in a hierarchal structure, and
a hierarchy message that indicates another activity element in the hierarchal structure that is superordinate to the activity element for which the trail selected by the user is defined is additionally posted to the channel associated with the activity element for which the trail is defined.

10. The information processing device according to claim 2, wherein
in the activity management service, a plurality of activity elements are defined in a hierarchal structure, and
a hierarchy message that indicates another activity element in the hierarchal structure that is superordinate to the activity element for which the trail selected by the user is defined is additionally posted to the channel associated with the activity element for which the trail is defined.

11. The information processing device according to claim 3, wherein
in the activity management service, a plurality of activity elements are defined in a hierarchal structure, and
a hierarchy message that indicates another activity element in the hierarchal structure that is superordinate to the activity element for which the trail selected by the user is defined is additionally posted to the channel associated with the activity element for which the trail is defined.

12. The information processing device according to claim 4, wherein
in the activity management service, a plurality of activity elements are defined in a hierarchal structure, and
a hierarchy message that indicates another activity element in the hierarchal structure that is superordinate to the activity element for which the trail selected by the user is defined is additionally posted to the channel associated with the activity element for which the trail is defined.

13. The information processing device according to claim 5, wherein
in the activity management service, a plurality of activity elements are defined in a hierarchal structure, and
a hierarchy message that indicates another activity element in the hierarchal structure that is superordinate to the activity element for which the trail selected by the user is defined is additionally posted to the channel associated with the activity element for which the trail is defined.

14. The information processing device according to claim 6, wherein
in the activity management service, a plurality of activity elements are defined in a hierarchal structure, and
a hierarchy message that indicates another activity element in the hierarchal structure that is superordinate to the activity element for which the trail selected by the user is defined is additionally posted to the channel associated with the activity element for which the trail is defined.

15. The information processing device according to claim 7, wherein
in the activity management service, a plurality of activity elements are defined in a hierarchal structure, and
a hierarchy message that indicates another activity element in the hierarchal structure that is superordinate to the activity element for which the trail selected by the user is defined is additionally posted to the channel associated with the activity element for which the trail is defined.

16. The information processing device according to claim 8, wherein
in the activity management service, a plurality of activity elements are defined in a hierarchal structure, and
a hierarchy message that indicates another activity element in the hierarchal structure that is superordinate to the activity element for which the trail selected by the user is defined is additionally posted to the channel associated with the activity element for which the trail is defined.

17. A non-transitory computer readable medium storing a program causing a computer to execute a process for processing information, the process comprising:
causing an activity element identifier that identifies an activity element defined in an activity management service, and for which a trail that indicates an electronic document to be registered is plurally defined, to be stored in a memory in association with a channel identifier that identifies a channel defined in a communication service; and
causing a trail message indicating the trail selected by a user in the activity management service to be posted to the channel associated with the activity element for which the trail is defined.

18. An information processing device comprising:
means for causing an activity element identifier that identifies an activity element defined in an activity management service, and for which a trail that indicates an electronic document to be registered is plurally defined, to be stored in a memory in association with a channel identifier that identifies a channel defined in a communication service; and
means for causing a trail message indicating the trail selected by a user in the activity management service to be posted to the channel associated with the activity element for which the trail is defined.
